(19) United States
(12) Patent Application Publication
(10) Pub. No.: US 2010/0247215 A1
(43) Pub. Date: Sep. 30, 2010

(54) NEAR-END OF ROLL DETECTING APPARATUS FOR DETECTING NEAR-END OF ROLL OF RECORDING MEDIUM, AND PRINTER

(75) Inventors: Hiroyuki TSUGARU, Saitama (JP); Tetsuya YAMAMOTO, Tokyo (JP); Katsutoshi MUKAIJIMA, Tokyo (JP); Gen MATSUSHIMA, Tokyo (JP)

Correspondence Address: MYERS WOLIN, LLC, 100 HEADQUARTERS PLAZA, North Tower, 6th Floor, MORRISTOWN, NJ, 07960-6834, US

(73) Assignees: CITIZEN HOLDINGS CO., LTD., Tokyo (JP); CITIZEN SYSTEMS JAPAN CO., LTD., Tokyo (JP)

(21) Appl. No.: 12/722,882

(22) Filed: Mar. 12, 2010

(30) Foreign Application Priority Data
Mar. 30, 2009 (JP) 2009-082829

(51) Int. Cl. B41J 15/00; B65H 20/00

(52) U.S. Cl. 400/578; 226/100

(57) ABSTRACT

A printer includes a recording medium accommodating unit that holds an outer circumferential portion of a recording medium wound in a roll, a printing unit that prints on the recording medium fed from the recording medium accommodating unit, a first detecting lever that is biased to abut a side aspect of the recording medium and that includes on a tip, a first protrusion that enters a space of a roll-core part in the center of the recording medium when the roll-core part is moved to a predetermined position by the weight of the recording medium as the recording medium is consumed, and a detecting switch that converts an action of the first detecting lever into an electric signal, where the first protrusion is provided on the first detecting lever being rotatable in a direction that the roll-core part moves to be detached from the recording medium accommodating unit.

### CROSS-REFERENCE TO RELATED APPLICATIONS

This application is based upon and claims the benefit of priority of the prior Japanese Patent Application No. 2009-082829, filed Mar. 30, 2009, now pending, the entire contents of which are herein wholly incorporated by reference.

### BACKGROUND OF THE INVENTION

1. Field of the Invention

The present invention relates to a near-end of roll detecting apparatus that detects a near-end of roll state with respect to a recording medium wound in a roll, and a printer that includes the near-end of roll detecting apparatus and that prints on the recording medium wound in a roll.

2. Description of the Related Art

For example, among printers that print on a recording medium wound in a roll, are those configured to support, from below, the recording medium wound in a roll. In such a printer, the position of a roll-core part in the center of the recording medium wound in a roll varies in the printer due to the weight of the recording medium and decreases in the outer diameter of the recording medium associated with consumption of the recording medium.

A printer has conventionally been present that includes a protrusion configured to be engaged with the roll-core part in the center of the recording medium that has moved to a predetermined position in consequence of consumption, and that is configured to detect that the remaining amount of the recording medium is a predetermined amount or less, i.e., a near end, by detecting that the protrusion is engaged with the roll-core part in the center of the recording medium wound in a roll. When the near end is detected, a user of the printer sets a new recording medium as necessary. When a new recording medium is set, the roll-core of the recording medium having a remaining amount that is the predetermined amount or less is detached and a new recording medium is set.

More specifically, for example, a technique has conventionally been present according to which, in a roll paper near-end detecting apparatus including a holding frame that holds a roll of paper at its outer circumference, a holder that is biased toward the inside of the holding frame from a side of the roll of paper held by the holding frame and that is disposed such that the holder may enter a paper tube of the roll of paper, and a sensor that is disposed at a predetermined distance from the holder and biased toward the inside of the holding frame from the side of the roll of paper; the holder and the sensor are each provided with a tapered portion to facilitate movement of the roll of paper in a direction for the roll of paper to be removed from the holding frame (see, e.g., Patent Document 1 below).

More specifically, for example, a technique has conventionally been present according to which, in a printer that includes a holder to accommodate a roll of recording paper, a printing head printing on the roll of recording paper, a sensor entering a space of a roll-core part of the recording paper when the remaining amount of the recording paper accommodated in the holder is a predetermined amount or less, a detecting lever having a protrusion disposed at a predetermined spacing from the sensor, and a detecting switch converting an action of the detecting lever into an electric signal, and that is adapted to have a tip of the sensor and a tip of the protrusion that are present in a substantially identical plane of a side aspect of the roll of recording paper when the sensor comes into contact with the side aspect of the roll recording paper; usability for removing the roll-core part is improved by preventing the roll-core part from being hooked by the protrusion by providing a slope in the lower portion of the protrusion (see, e.g., Patent Document 2 below).

A roll paper printer has conventionally been present that includes a roll paper accommodating unit, an opening and closing cover to open or close the roll paper accommodating unit, a detecting lever being pushed against a side aspect of a roll of paper accommodated in the roll paper accommodating unit and including a detecting protrusion to be inserted into a core hole of the roll of paper when the core hole is lowered to a position at a predetermined height, a detecting protrusion retracting mechanism that retracts the detecting protrusion of the detecting lever protruding into the roll paper accommodating unit by the roll paper accommodating unit being interlocked with an opening action of the opening and closing of the cover (see, e.g., Patent Document 3 below).

[Patent Document 1] Japanese Patent Application Laid-Open Publication No. 2001-199604

[Patent Document 2] Japanese Patent Publication No. 3536842

[Patent Document 3] Japanese Patent Application Laid-Open Publication No. 2007-45556

However, in the conventional techniques described in Patent Documents 1 and 2 above, the roll-core part in the center of the recording medium wound in a roll and the protrusion (the sensor) interfere with each other during replacement of the recording medium wound in a roll and therefore, a problem arises in that workability is diminished.

On the other hand, when the angle of the tapered portion (slope) provided on the protrusion (sensor) with respect to the direction of the core center of the recording medium is adjusted to reduce the interference between the roll-core part in the center of the recording medium wound in a roll and the protrusion (sensor), a problem arises in that the precision in detecting the near end by the protrusion (sensor) is reduced.

In the conventional technique described in Patent Document 3 above, the mechanism to retract the detecting protrusion of the detecting lever protruding into the roll paper accommodating unit by the roll paper accommodating unit being interlocked with the opening action of the opening and closing of the cover is complicated and therefore, a problem arises in that the number of parts becomes large.

To solve the problems associated with the conventional techniques above, an object of the present invention is to provide a near-end of roll detecting apparatus and a printer that simplify replacement of a recording medium wound in a roll while securing precise detection of a near end.

### SUMMARY OF THE INVENTION

To solve the problems above and achieve an object, a near-end of roll detecting apparatus according to the present invention includes a recording medium accommodating unit that holds an outer circumferential portion of a recording medium wound in a roll; a detecting lever that is biased to abut a side aspect of the recording medium, and has on a tip, a protrusion that enters a space of a roll-core part in a center of the recording medium when the roll-core part is moved to a predetermined position by the weight of the recording medium as the recording medium is consumed; and a detecting switch that converts an action of the detecting lever into an electric signal, where the protrusion is provided on the detecting lever being rotatable in a direction that the roll-core part moves to be detached from the recording medium accommodating unit.

According to the present invention, accompanying the movement of the roll-core part when detached from the recording medium accommodating unit, the protrusion rotates in the direction that the roll-core part moves when detached from the recording medium accommodating unit and thereby, the roll-core is detached easily. Thus, simplification of the detaching operation of the recording medium is facilitated without changing the shape of the protrusion necessary for detecting the near end.

Further in the near-end of roll detecting apparatus according to the present invention, the protrusion is biased in a direction opposite to the direction that the roll-core part moves to be detached from the recording medium accommodating unit.

According to the present invention, a state where the protrusion abuts the side face of the recording medium is restored after the roll-core part is detached and therefore, the preparation for detecting the remaining amount of a new recording medium may be completed by merely accommodating the new recording medium in the recording medium accommodating unit. Thereby, simplification of attaching operation of the recording medium is facilitated without changing the shape of the protrusion necessary for detecting the near end.

Further, in the near-end of roll detecting apparatus according to the present invention, the protrusion is provided being rotatable about a shaft that is provided on the detecting lever, is perpendicular to the direction that the roll-core part moves to be detached from the recording medium accommodating unit, and is parallel to the side aspect of the recording medium.

According to the present invention, with a simple configuration, the roll-core part provided on the detecting lever is rotated assuredly in the direction that the roll-core part provided on the detecting lever moves when detached from the recording medium accommodating unit. Thereby, an increase of the size of a printer due to sophistication of the configuration related to detection of the near end may be suppressed, facilitating downsizing of the printer.

A printer according to the present invention includes a printing unit that prints on the recording medium fed from the recording medium accommodating unit; and the near-end of roll detecting apparatus above.

According to the present invention, compared to the conventional apparatuses or configurations that detect a near-end of roll state of recording medium, simplification of detaching operation of the recording medium may be facilitated without changing the shape of the protrusion to detect the near end. Thereby, simplification of detaching operation and attaching operation of the recording medium may be facilitated ensuring accuracy in detecting the near end.

### EFFECT

According to the printer of the present invention, an effect is achieved that simplification of detaching operation and attaching operation of a recording medium is facilitated without changing the shape of a protrusion necessary for detecting a near end and therefore, simplification of replacing operation of a recording medium wound in a roll is facilitated ensuring accuracy in detecting the near end.

### BRIEF DESCRIPTION OF THE DRAWINGS

FIG. 1 is a diagram for explaining a printer apparatus according to an embodiment of the present invention (part 1);

FIG. 2 is a diagram for explaining the printer apparatus according to the embodiment of the present invention (part 2);

FIG. 3 is a diagram for explaining the printer apparatus according to the embodiment of the present invention (part 3);

FIG. 4 is a diagram for explaining the printer apparatus according to the embodiment of the present invention (part 4);

FIG. 5 is a diagram for explaining a remaining amount detecting mechanism (part 1);

FIG. 6 is a diagram for explaining the remaining amount detecting mechanism (part 2);

FIG. 7 is a diagram for explaining the remaining amount detecting mechanism (part 3);

FIG. 8 is a diagram for explaining the remaining amount detecting mechanism (part 4);

FIG. 9 is a diagram for explaining a configuration of a first protrusion (part 1);

FIG. 10 is a diagram for explaining the configuration of the first protrusion (part 2);

FIG. 11 is a diagram for explaining the configuration of the first protrusion (part 3);

FIG. 12 is a diagram for explaining the configuration of the first protrusion (part 4);

FIG. 13 is a diagram for explaining a detection method used by the remaining amount detecting mechanism (part 1);

FIG. 14 is a diagram for explaining the detection method used by the remaining amount detecting mechanism (part 2);

FIG. 15 is a diagram for explaining operation of the remaining amount detecting mechanism during replacement of recording medium wound in a roll (part 1); and

FIG. 16 is a diagram for explaining the operation of the remaining amount detecting mechanism during replacement of recording medium wound in a roll (part 2).

### DETAILED DESCRIPTION OF THE PREFERRED EMBODIMENTS

Preferred embodiments of a printer according to the present invention will be described in detail with reference to the accompanying drawings. In these embodiments, applications of a printer apparatus that includes a printer according to the present invention will be exemplified.

### Embodiment

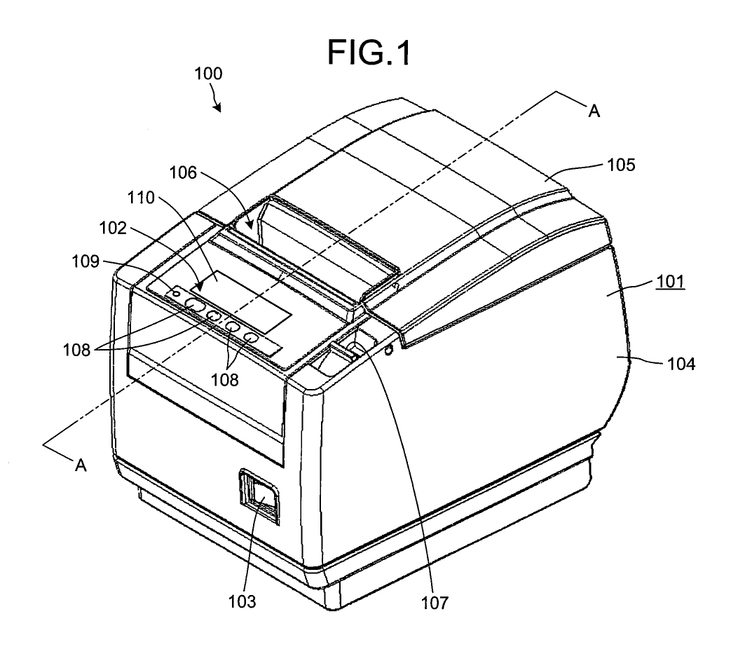

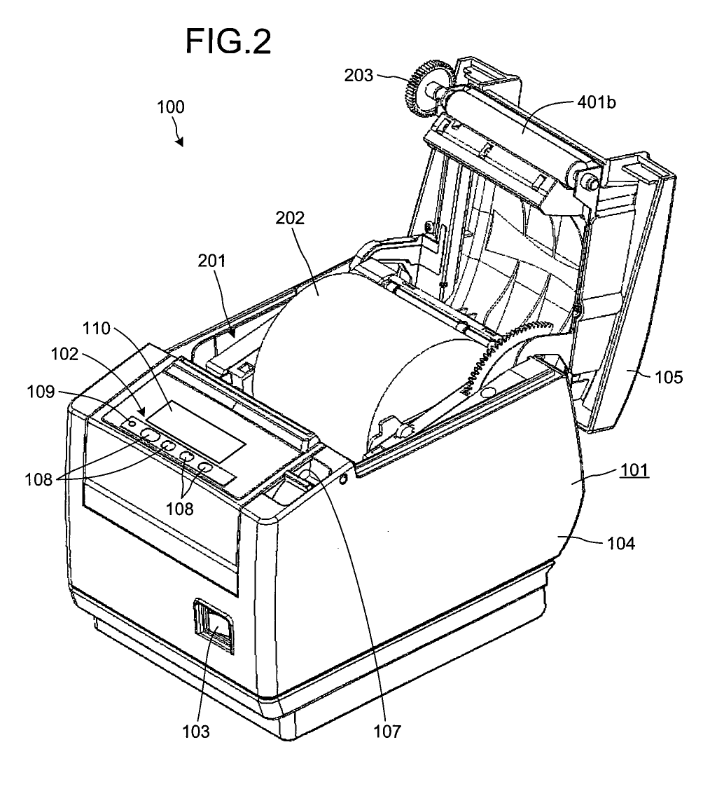

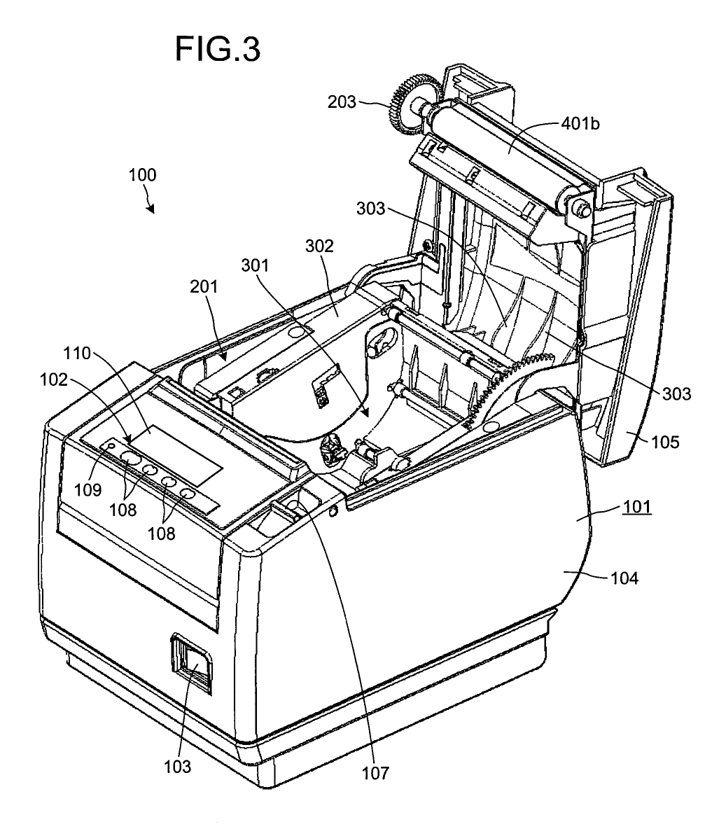

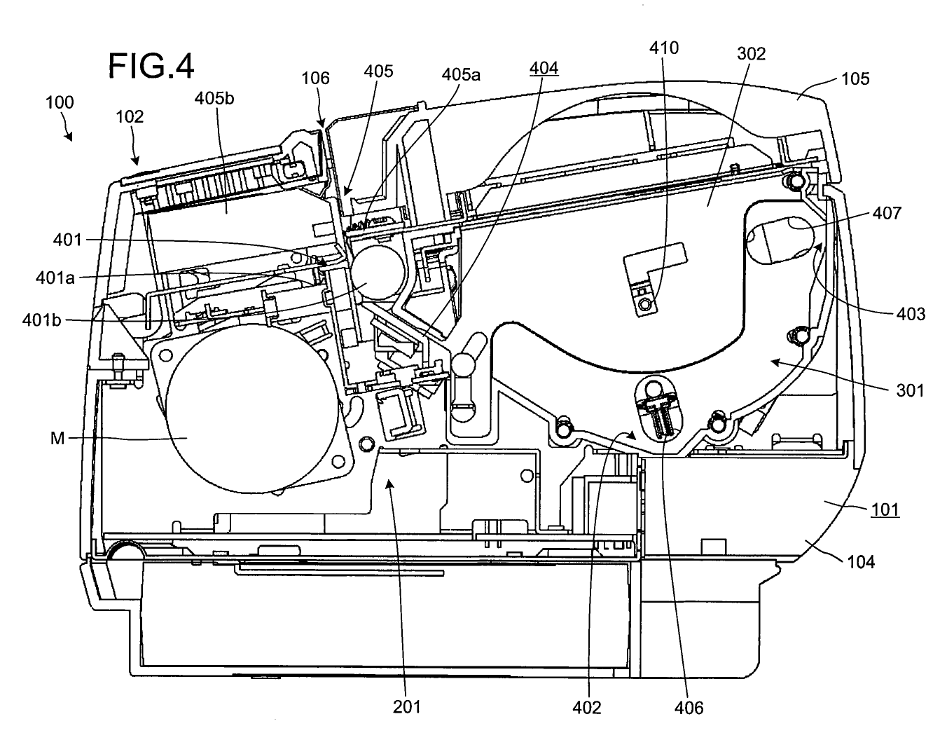

A printer apparatus according to an embodiment of the present invention will be described. FIGS. 1 to 4 are diagrams for explaining the printer apparatus according to the embodiment of the present invention. FIGS. 1 to 3 are diagrams depicting external views of the printer apparatus according to the embodiment of the present invention. FIG. 4 depicts a cross section (along an A-A line in FIG. 1) of the printer apparatus according to the embodiment of the present invention.

In FIGS. 1 to 4, the printer apparatus 100 according to the embodiment of the present invention includes a casing 101 that has a substantially box shape. A printer 201 is provided inside the casing 101.

An operation panel 102 is provided at one aspect of the casing 101. The operation panel 102 is equipped with operation keys 108 for receiving various instructions for the printer apparatus 100, an LED lamp 109 that indicates the state of the printer apparatus 100, and a liquid crystal displaying unit 110 that indicates the state of the printer apparatus 100 using characters or symbols. A power switch 103 that switches the power of the printer apparatus 100 to ON and OFF is provided at another aspect of the casing 101.

When the power of the printer apparatus 100 is turned on and the printer apparatus 100 is in a printing stand-by state, when an error occurs in the printer apparatus 100, when the remaining amount of a recording medium 202 in the printer apparatus 100 is a predetermined amount or less, etc., the LED lamp 109 is lit or is caused to blink and information is displayed on the liquid crystal displaying unit 110, thereby giving notification of the above situations.

The printing apparatus 100 includes a sound output apparatus that outputs predetermined sounds. The sound output apparatus outputs spoken directions or a warning sound when an error occurs in the printer apparatus 100, when the remaining amount of the recording medium 202 in the printer apparatus 100 is a predetermined amount or less, etc.

More specifically, the sound output apparatus may be implemented by, for example, a speaker. Alternatively, more specifically, the sound output apparatus may be implemented by, for example, a buzzer. The sound output apparatus may be implemented easily using various known techniques and therefore, will not be described. The recording medium 202 has a long strip-shape and is wound from an end thereof along a longitudinal direction about a core into a roll.

The casing 101 includes a casing main body 104 that supports the printer 201, and a printer cover 105 that is joined to the casing main body 104. The printer cover 105 is joined to the casing main body 104 such that the interior of the casing main body 104 is enclosed and accessible via the printer cover 105.

A locking mechanism, not depicted, is provided between the casing main body 104 and the printer cover 105. When the printer cover 105 is positioned such that the interior of the casing main body 104 becomes enclosed, the locking mechanism is engaged and fixes the position of the printer cover 105 with respect to the casing main body 104.

In the casing 101, a recording medium discharge opening 106 is formed by a gap formed between the casing main body 104 and the printer cover 105 when the interior of the casing main body 104 is enclosed by the printer cover 105. The recording medium discharge opening 106 communicatively connects the interior of the casing 101 to the outside thereof, and discharges therethrough the recording medium 202 on which printing is executed by a printing unit 401 included in the printer 201 housed in the casing 101, to the outside of the casing 101. The recording medium 202 is wound in a roll and accommodated in a recording medium accommodating unit 301 included in the printer apparatus 100. The recording medium accommodating unit 301 supports an outer circumferential portion of the recording medium 202 wound in a roll.

On one aspect of the casing 101, a lock release lever 107 is provided that disengages the engagement of the locking mechanism when the lock release lever 107 is manipulated by a user, etc., of the printer apparatus 100. When the lock release lever 107 is manipulated and the engagement of the locking mechanism is disengaged, the printer cover 105 moves in a direction widening the recording medium discharge opening 106 with respect to the casing main body 104 and thereby, opens the recording medium accommodating unit 301.

In a state where the printer cover 105 is moved in an opening direction and the recording medium accommodating unit 301 is opened to the exterior, the recording medium 202 wound in a roll may be put in the recording medium accommodating unit 301, the recording medium 202 accommodated in the recording medium accommodating unit 301 may be removed from the recording medium accommodating unit 301, etc. The lock release lever 107 is manipulated when, for example, the remaining amount of the recording medium 202 accommodated in the recording medium accommodating unit 301 is an insufficient amount and a new recording medium 202 is to be set.

The recording medium accommodating unit 301 includes a box-shaped member 302 and accommodating unit ribs 303. The box-shaped member 302 is supported by the casing 101, has a bottom portion curved in a substantially semicircular shape, and has a shape of which one aspect facing toward the bottom portion is open. The accommodating unit ribs 303 are provided on the printer cover 105 and protrude toward the box-shaped member 302. The box-shaped member 302 and the accommodating unit ribs 303 form the recording medium accommodating unit 301 whose cross section is substantially circular when the printer cover 105 is fixed to the casing main body 104.

The recording medium accommodating unit 301 includes a first and a second recording medium holding unit 402 and 403. The first recording medium holding unit 402 holds the recording medium 202 when the printer apparatus 100, i.e., the printer 201, is in a first installation state. The second recording medium holding unit 403 holds the recording medium 202 when the printer apparatus 100, i.e., the printer 201, is in a second installation state that is different from the first installation state.

In the embodiment, the first installation state is a state where the printer apparatus 100 is installed with the recording medium discharge opening 106 facing vertically upward in the printer apparatus 100. In the embodiment, the second installation state is a state where the printer apparatus 100 is installed with the recording medium discharge opening 106 being in an orientation that crosses the vertical orientation, i.e., faces forward toward the user of the printer 201.

The first recording medium holding unit 402 is curved at a curvature that is equal to or larger than that of the maximal outer diameter of the recording medium 202 wound in a roll to be accommodated in the recording medium accommodating unit 301, and is a member that has a curved shape of which a lower end protrudes downward when the printer 201 is in the first installation state. The first recording medium holding unit 402 may be implemented by a portion of the bottom portion of the recording medium accommodating unit 301.

Thus, when the printer 201 is in the first installation state, the recording medium 202 wound in a roll is moved by its own weight as the recording medium 202 is consumed such that the recording medium 202 is received in the lower end of the curved aspect formed by the first recording medium holding unit 402. In the embodiment, the first recording medium holding unit 402 frontally faces the printer cover 105 and is a curved aspect that is curved such that a portion thereof that is more central becomes more distant from the printer cover 105. The first recording medium holding unit 402 may be implemented by a portion of the bottom portion of the recording medium accommodating unit 301.

The second recording medium holding unit 403 is curved at a curvature that is equal to or larger than that of the maximal outer diameter of the recording medium 202 wound in a roll to be accommodated in the recording medium accommodating unit 301; and may be implemented by a member that forms a curved aspect of which a lower end protrudes downward when the printer 201 is in the second installation state.

Thus, when the printer 201 is in the second installation state, the recording medium 202 wound in a roll is moved by its own weight as the recording medium 202 is consumed such that the recording medium 202 is received in the lower end of the curved aspect formed by the second recording medium holding unit 403. In the embodiment, the second recording medium holding unit 403 may be implemented by a wall surface provided standing such that the wall surface crosses the printer cover 105.

When the printer cover 105 is fixed to the casing main body 104, a recording medium conveyance path 404 is formed in the casing 101. The recording medium conveyance path 404 communicatively connects the recording medium accommodating unit 301 and the recording medium discharge opening 106. The recording medium conveyance path 404 communicatively connects the recording medium accommodating unit 301 and the recording medium discharge opening 106 through the printing unit 401.

The printing unit 401 prints characters, etc., on the recording medium 202 conveyed from the recording medium accommodating unit 301 to the recording medium discharge opening 106. The printing unit 401 is not limited to one that prints characters, and may print items other than characters such as symbols, given logo marks, and other images. In the embodiment, the printing unit 401 prints under a thermal printing scheme.

The printing unit 401 includes a printing head 401a and a platen 401b. The printing head 401a and the platen 401b are disposed facing each other sandwiching the recording medium conveyance path 404 therebetween. For example, the printing unit 401 that prints under a thermal printing scheme may include a thermal-printing-scheme printing head (thermal head) 401a and the platen 401b.

For example, the thermal-printing-scheme printing head (thermal head) 401a includes multiple heating elements arranged in a line along the width direction of the recording medium 202, selectively energizes the heating elements to selectively cause the heating elements to heat and thereby, prints characters, etc. The printer 201 including the printing unit 401 that prints under a thermal printing scheme as described above uses the recording medium 202 that has a thermal color developing property. The thermal-printing-scheme printing head 401a and a control method of the printing head 401a may be implemented easily using various known techniques and therefore, will not be described.

The platen 401b has a substantially columnar shape having an axial center direction crossing the direction of the conveyance of the recording medium 202 (a direction penetrating the paper hereof FIG. 4). An end of a shaft of the platen 401b is fitted with a gear 203. The gear 203 is rotated by a driving force transmitted to the gear 203 from a motor M that is provided in the casing main body 104. The platen 401b rotates with the rotation of the gear 203. The motor M and the gear 203 are engaged through a gear not depicted.

The platen 401b faces the printing head 401a sandwiching therebetween the recording medium 202 that is conveyed in the recording medium conveyance path 404, and during printing, supports the recording medium 202 from a back surface against a printing force induced by the printing head 401a. The platen 401b conveys the printed recording medium 202 from the recording medium accommodating unit 301 to the recording medium discharge opening 106 by rotating about the axial center.

In the recording medium conveyance path 404, a cutting mechanism 405 is provided at a position that is closer to the recording medium discharge opening 106 than the printing unit 401. The cutting mechanism 405 includes a fixed blade 405a whose position is fixed and a moveable blade, not depicted, provided at a position such that the moveable blade faces the fixed blade 405a sandwiching the recording medium conveyance path 404 therebetween. The fixed blade 405a is provided on the printer cover 105. The moveable blade is provided movably in directions causing the moveable blade to come into contact with and move away from the fixed blade 405a. The moveable blade is provided in the casing main body 104.

In the embodiment, the moveable blade is provided in a moveable blade unit 405b that is configured by integrating the moveable blade and mechanisms to move the moveable blade into one unit. The moveable blade unit 405b is detachably provided in the casing main body 104. When the moveable blade is worn or when any of the mechanisms to move the moveable blade become aged, the moveable blade unit 405b may be replaced.

When the recording medium 202 is positioned between the fixed blade 405a and the moveable blade, the cutting mechanism 405 cuts the recording medium 202 positioned between the fixed blade 405a and the moveable blade by causing the moveable blade to come into contact with the fixed blade 405a. Thereby, the cutting mechanism 405 cuts, at an arbitrary length, the recording medium 202 on which printing has been executed by the printing unit 401.

After cutting the recording medium 202, the cutting mechanism 405 moves the moveable blade in a direction causing the moveable blade to move away from the fixed blade 405a to form a gap between the fixed blade 405a and the moveable blade. By rotating the platen 401b in this state, the recording medium 202 accommodated in the recording medium accommodating unit 301 is sent out being unrolled toward the recording medium discharge opening 106. Thereby, the recording medium 202 may be subjected to the next printing.

The recording medium 202 wound in a roll and accommodated in the recording medium accommodating unit 301 is pulled out starting from an outer circumference and is fed to the printing unit 401 by the rotation of the platen 401b to send out the recording medium 202, unrolling toward the recording medium discharge opening 106. The recording medium 202 wound in a roll is rotated in the recording medium accommodating unit 301 by being pulled out starting from the outer circumference. In the recording medium accommodating unit 301, the recording medium 202 wound in a roll is rotated about the shaft around which the recording medium 202 is wound into a roll.

Therefore, in a state where the recording medium 202 wound in a roll can be rotated about the shaft of the recording medium 202, the recording medium accommodating unit 301 accommodates and holds the recording medium 202 wound in a roll. When the recording medium 202 wound in a roll is accommodated in the recording medium accommodating unit 301, the recording medium 202 is held from below in the vertical direction by the first recording medium holding unit 402 or the second recording medium holding unit 403, according to the installation state.

The printer 201 includes a remaining amount detecting mechanism that detects (senses) the remaining amount of the recording medium 202 wound in a roll and accommodated in the recording medium accommodating unit 301. The remaining amount detecting mechanism includes a first detecting unit that detects the remaining amount of the recording medium 202 wound in a roll and held in the first recording medium holding unit 402, and a second detecting unit that detects the remaining amount of the recording medium 202 wound in a roll and held in the second recording medium holding unit 403. The first and the second detecting units are provided such that detection by only one of them is activated.

The printer 201 includes a switching lever 410 that receives switching operations to switch the state of the remaining amount detecting mechanism such that detection by any one among the first and the second detecting units is activated. Which one of the first and the second detecting units is activated is determined by the user of the printer apparatus 100, according to the installation state of the printer apparatus 100, i.e., the printer 201.

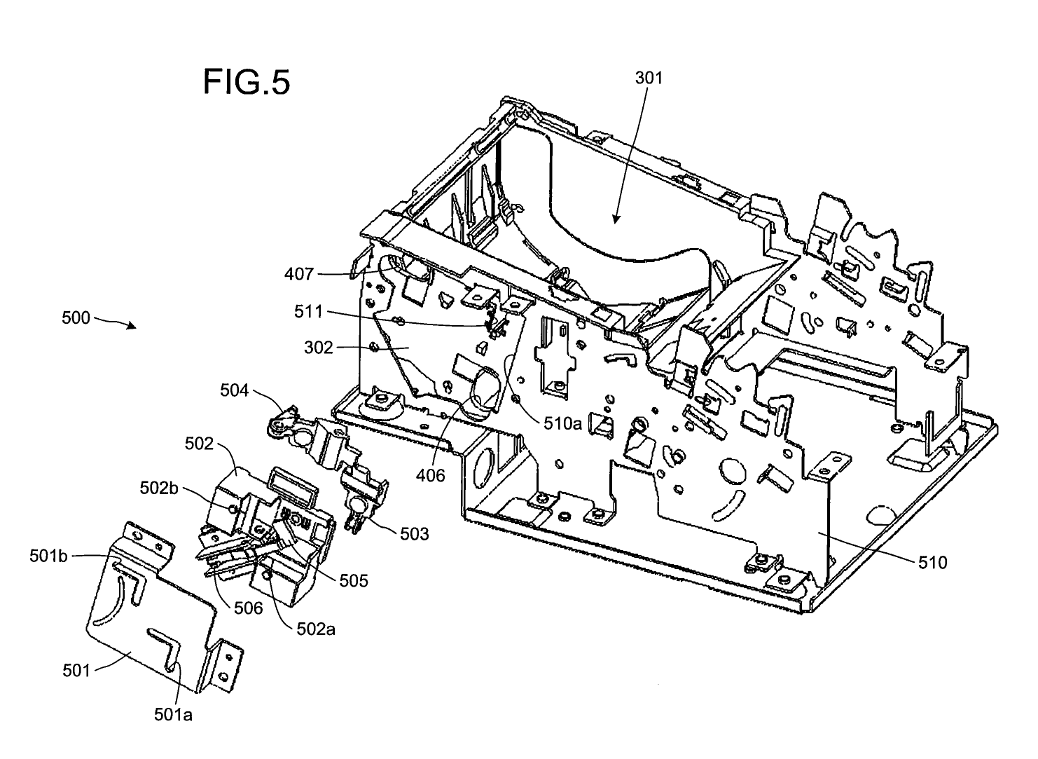

The user of the printer apparatus 100 switches the state of the remaining amount detecting mechanism by operating the switching lever 410 according to the installation state of the printer apparatus 100, i.e., the printer 201, such that any one among the first and the second detecting units is activated. In the printer apparatus 100, the state of the remaining amount detecting mechanism may be switched by operating the switching lever 410 such that detection by both the first and the second detecting units is deactivated. The remaining amount detecting mechanism and a switching mechanism will be described below (with reference to FIGS. 5 to 8).

The remaining amount detecting mechanism is provided in the casing main body 104 and external to the recording medium accommodating unit 301. The first detecting unit in the remaining amount detecting mechanism detects the remaining amount of the recording medium 202 wound in a roll and held in the first recording medium holding unit 402, through a first window 406 provided in the recording medium accommodating unit 301. The second detecting unit in the remaining amount detecting mechanism detects the remaining amount of the recording medium 202 wound in a roll and held in the second recording medium holding unit 403, through a second window 407 provided in the recording medium accommodating unit 301. FIG. 4 depicts a state where the first detecting unit is activated.

### (Configuration of Remaining Amount Detecting Mechanism)

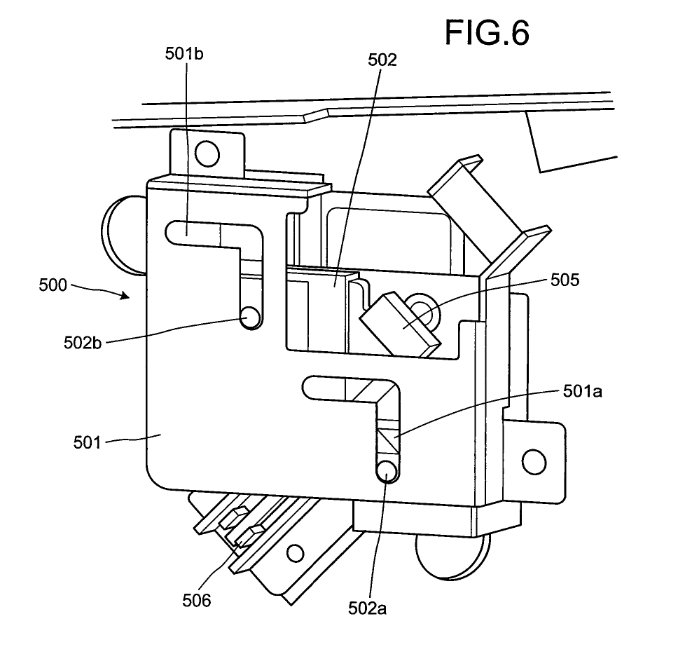

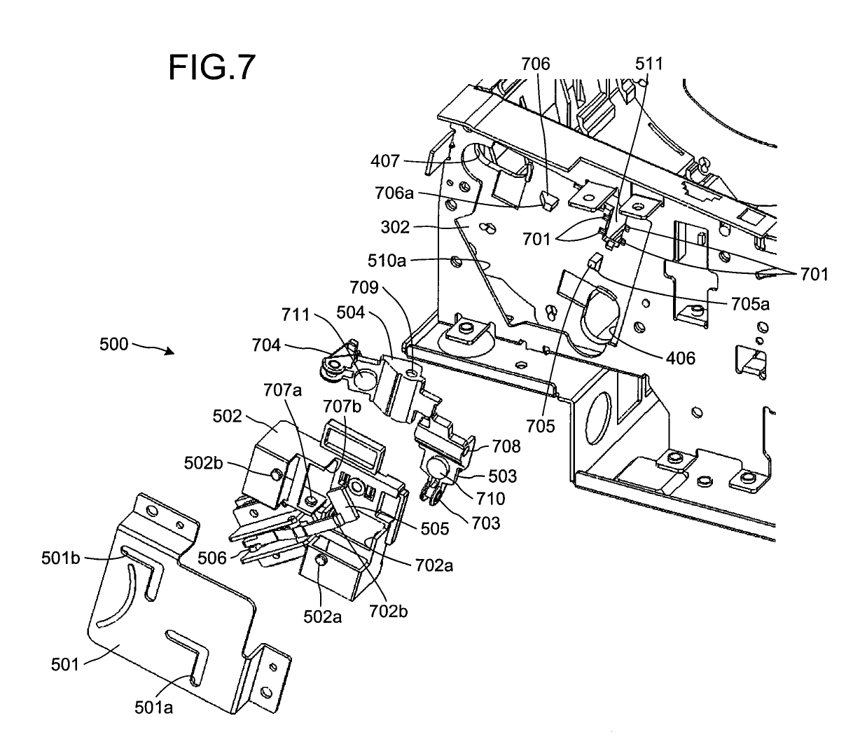

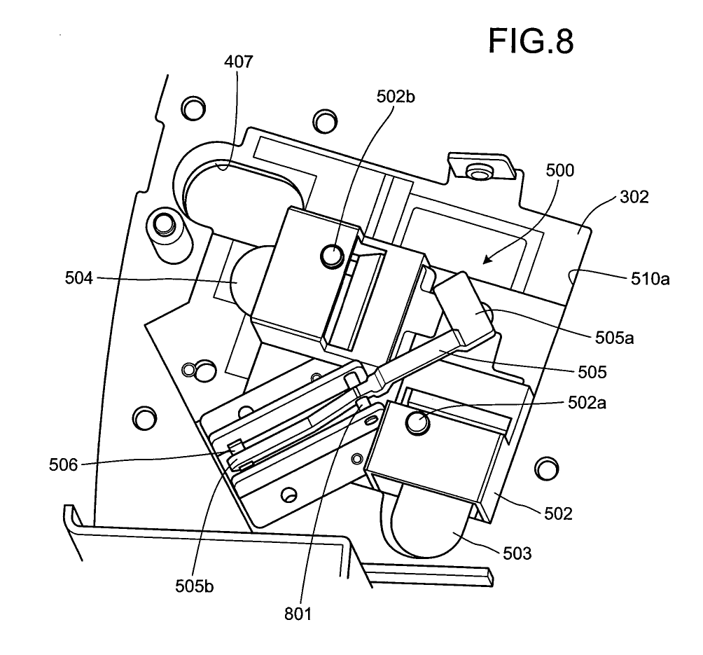

The configuration of the remaining amount detecting unit will be described. FIGS. 5 to 8 are diagrams for explaining the remaining amount detecting mechanism. FIG. 5 depicts the remaining amount detecting mechanism in a disassembled state and the position of the remaining amount detecting mechanism in the printer 201. FIG. 6 depicts the remaining amount detecting mechanism attached to the printer 201. FIG. 7 is an exploded view of a portion of the remaining amount detecting mechanism depicted in FIG. 5. FIG. 8 depicts a portion of the remaining amount detecting mechanism attached to the printer 201.

In FIGS. 5 to 8, the remaining amount detecting mechanism 500 is provided in a vicinity of the recording medium accommodating unit 301 in the printer 201. The remaining amount detecting mechanism 500 includes a unit covering member 501, a unit frame member 502, a first detecting lever 503, a second detecting lever 504, an interlocked detecting lever 505, and a detection sensor 506.

In the embodiment, a detecting lever may be implemented by the first and the second detecting levers 503 and 504. In the embodiment, a detection switch may be implemented by the detection sensor 506 and the interlocked detecting lever 505. The unit covering member 501 is provided in the box-shaped member 302 that constitutes the recording medium accommodating unit 301 through an opening 510a provided in a main body frame 510 of the printer 201.

The unit frame member 502 is provided between the unit covering member 501 and the box-shaped member 302, and is configured to be movable in a space formed by the unit covering member 501 and the box-shaped member 302. The switching lever 410 is provided being integrated into the unit frame member 502. The switching lever 410 is engaged with a slit 511 provided in the box-shaped member 302 and penetrates the slit 511 toward the recording medium accommodating unit 301.

The switching lever 410 is engaged with the slit 511 being movable along the slit 511. When the switching lever 410 is moved along the slit 511, the position of the unit frame member 502 relative to that of the recording medium accommodating unit 301 changes. The slit 511 has a substantially L-shape, whereby the unit frame member 502 moves along a substantially L-shaped trace.

In the slit 511, a hooking recess 701 is provided between a curved portion and each of the two ends of the slit 511. The switching lever 410 includes a hooking protrusion not depicted that may be hooked in the hooking recess 701. The position of the switching lever 410 in the slit 511 may be stopped by hooking the hooking protrusion in the hooking recess 701.

With such a configuration, the position of the unit frame member 502 relative to that of the recording medium accommodating unit 301 may be adjusted and the position of the unit frame member 502 relative to that of the recording medium accommodating unit 301 may be fixed.

In the embodiment, the hooking recess 701 is provided at each of five points including the two ends, the curved portion of the slit 511, and two points between the curved portion and the two ends. Thereby, the position of the unit frame member 502 relative to that of the recording medium accommodating unit 301 may be fixed at any one of the five points.

The positions of the hooking recesses 701 are not limited to the above five points. The hooking recesses 701 may be provided at three points including the two ends and the curved portion of the slit 511, or may be provided at more points than the above five points. By increasing the points for the hooking recesses 701, the position of the unit frame member 502 relative to that of the recording medium accommodating unit 301 may be finely adjusted.

The unit frame member 502 includes protrusions 502a and 502b that are hooked in slits 501a and 501b provided in the unit covering member 501. The slits 501a and 501b each have a substantially L-shape similar to the above slit 511 such that the slits 501a and 501b guide the moving positions of the protrusions 502a and 502b that move together with the unit frame member 502 by an operation of the switching lever 410.

The protrusions 502a and 502b provided on the unit frame member 502 and the slits 501a and 501b that are engaged with the protrusions 502a and 502b are provided at positions that are different from those of the slit 511 and the switching lever 410 in a direction that the unit covering member 501 and the unit frame member 502 overlap.

When the slit 511 and the switching lever 410 are engaged with each other on the side of the recording medium accommodating unit 301, the slits 501a and 501b and the protrusions 502a and 502b are engaged with each other on the side opposite to that of the recording medium accommodating unit 301 and thereby, the box-shaped member 302 and the unit covering member 501 holds the unit frame member 502 sandwiching the unit frame member 502 therebetween and thus, the moving position of the unit frame member 502 may be guided. Thereby, the unit frame member 502 is moved stably and precisely.

The first detecting lever 503 is joined to the unit frame member 502 by fitting a first shaft portion 702 including a pair of protrusions 702a and 702b provided facing each other in the unit frame member 502, into a hole 708. Similarly, the second detecting lever 504 is joined to the unit frame member 502 by fitting a second shaft portion 707 including a pair of protrusions 707a and 707b provided facing each other in the unit frame member 502, into a hole 709. The first and the second detecting levers 503 and 504 are provided respectively in the unit frame member 502 swingably about the first and the second shaft portions 702 and 707 as the fulcrums.

The first and the second detecting levers 503 and 504 are joined to the unit frame member 502 in a state where the axial center directions of the first and the second shaft portions 702 and 707 cross each other. In the embodiment, the first and the second detecting levers 503 and 504 are provided such that the axial center directions of the first shaft portion 702 that is fitted with the first detecting lever 503 and the second shaft portion 707 that is fitted with the second detecting lever 504 cross each other at 90 degrees upon swinging.

The first detecting lever 503 is provided such that, in a case where the printer 201 is in the first installation state, when the shaft of the recording medium 202 wound in a roll moves as the recording medium 202 is consumed, the first detecting lever 503 swings parallel to the direction of the movement. The second detecting lever 504 is provided such that, in a case where the printer 201 is in the second installation state, when the shaft of the recording medium 202 wound in a roll moves as the recording medium 202 is consumed, the second detecting lever 504 swings parallel to the direction of the movement.

An end of the first detecting lever 503 has a first protrusion 703 that protrudes toward the first window 406, i.e., the recording medium accommodating unit 301. A first compression coil spring, not depicted, is provided between a cylinder-like protrusion 710 provided on the first detecting lever 503 and the unit frame member 502. The first detecting lever 503 is biased in a direction to protrude the first protrusion 703 from the first window 406 by the restoring force of the first compression coil spring.

An end of the second detecting lever 504 has a second protrusion 704 that protrudes toward the second window 407, i.e., the recording medium accommodating unit 301. A second compression coil spring, not depicted, is provided between a cylinder-like protrusion 711 provided on the second detecting lever 504 and the unit frame member 502. The second detecting lever 504 is biased in a direction to protrude the second protrusion 704 from the second window 407 by the restoring force of the second compression coil spring.

The interlocked detecting lever 505 is coupled to the unit frame member 502 by fitting a shaft portion 801 formed protruding from both sides about the center into a hole provided in the unit frame member 502, and is provided in the unit frame member 502 swingably about the shaft portion 801 as the fulcrum. The interlocked detecting lever 505 is provided such that an end 505a thereof faces an end opposite to the first protrusion 703 of the first detecting lever 503 and an end opposite to the second protrusion 704 of the second detecting lever 504 and another end 505b thereof faces the detection sensor 506.

The shaft portion 801 of the interlocked detecting lever 505 has a helical torsion coil spring, not depicted. The helical torsion coil spring biases the interlocked detecting lever 505 such that the end 505a of the interlocked detecting lever 505 abuts the end opposite to the first protrusion 703 of the first detecting lever 503 and the end opposite to the second protrusion 704 of the second detecting lever 504 keeping the other end 505b of the interlocked detecting lever 505 away from the detection sensor 506.

The biasing force of the helical torsion coil spring that biases the interlocked detecting lever 505 is set to be weaker than the biasing force of the first compression coil spring that biases the first detecting lever 503 and the biasing force of the second compression coil spring that biases the second detecting lever 504. Therefore, the interlocked detecting lever 505 is biased with respect to the end opposite to the first protrusion 703 of the first detecting lever 503 or the end opposite to the second protrusion 704 of the second detecting lever 504, and swings such that the other end 505b comes in a vicinity of the detection sensor 506.

The detection sensor 506 may be implemented by a transmission photoelectric sensor. Output from the detection sensor 506 varies according to the position of the interlocked detecting lever 505 relative to that of the detection sensor 506. The output of the detection sensor 506 varies corresponding to cases where the end 505a of the interlocked detecting lever 505 is biased with respect to the end opposite to the first protrusion 703 of the first detecting lever 503 or the end opposite to the second protrusion 704 of the second detecting lever 504, and the other end 505b comes in a vicinity of the detection sensor 506 being positioned such that the other end 505b obscures a light-emitting unit and a light-receiving unit of the detection sensor 506, and where the first detecting lever 503 resists the restoring force of the first compression coil spring and swings, and the second detecting lever 504 resists the restoring force of the second compression coil spring and swings, and the interlocked detecting lever 505 is swung by the biasing force of the helical torsion coil spring to a position at which the other end 505b is moved away from the detection sensor 506.

In the embodiment, the first detecting unit includes the first detecting lever 503; the first compression coil spring and the interlocked detecting lever 505 that act being interlocked to the swinging of the first detecting lever 503; and the unit frame member 502, and the unit covering member 501, etc., that support these components. In the embodiment, the second detecting unit includes the second detecting lever 504; the second compression coil spring and the interlocked detecting lever 505 that act being interlocked to the swinging of the second detecting lever 504; and the unit frame member 502, and the unit covering member 501, etc., that support these components.

When the first detecting unit is activated, the first detecting lever 503 is provided such that the first protrusion 703 faces the first window 406. The first detecting lever 503 is provided such that the end opposite to the first protrusion 703 faces the end 505a of the interlocked detecting lever 505 in a direction to stack the first detecting lever 503 and the interlocked detecting lever 505.

When the second detecting unit is activated, the second detecting lever 504 is provided such that the second protrusion 704 faces the second window 407. The second detecting lever 504 is provided such that the end opposite to the second protrusion 704 faces the end 505a of the interlocked detecting lever 505 in the direction to stack the second detecting lever 504 and the interlocked detecting lever 505.

When the first detecting unit is activated, the first protrusion 703 protrudes into the recording medium accommodating unit 301 through the first window 406. When the first detecting unit is activated and the remaining amount of the recording medium 202 accommodated in the recording medium accommodating unit 301 is of a sufficient amount, the first protrusion 703 abuts a side surface of the recording medium 202 wound in a roll. When the first protrusion 703 abuts the side surface of the recording medium 202 wound in a roll, the first detecting lever 503 resists the restoring force of the first compression coil spring and swings in a direction that the end opposite to the first protrusion 703 moves to move away from the end 505a of the interlocked detecting lever 505.

When the second detecting unit is activated, the second protrusion 704 protrudes into the recording medium accommodating unit 301 through the second window 407. When the second detecting unit is activated and the remaining amount of the recording medium 202 accommodated in the recording medium accommodating unit 301 is of a sufficient amount, the second protrusion 704 abuts a side surface of the recording medium 202 wound in a roll. When the second protrusion 704 abuts the side surface of the recording medium 202 wound in a roll, the second detecting lever 504 resists the restoring force of the second compression coil spring and swings in the direction that the end opposite to the second protrusion 704 moves to move away from the end 505a of the interlocked detecting lever 505.

In the remaining amount detecting mechanism 500, the switching lever 410 is provided in the unit frame member 502, and the first and the second detecting levers 503 and 504 are provided in the unit frame member 502. Therefore, when the unit frame member 502 is moved by operating the switching lever 410, the first detecting lever 503 and the second detecting lever 504 move interlocked with each other.

Therefore, when the first detecting lever 503 protrudes from the first window 406, the second detecting lever 504 is positioned such that the second detecting lever 504 is retracted from the second window 407. Similarly, when the second detecting lever 504 protrudes from the second window 407, the first detecting lever 503 is positioned such that the first detecting lever 503 is retracted from the first window 406.

In this manner, in the remaining amount detecting mechanism 500, the first and the second detecting units may be moved by operating the switching lever 410 to positions activating detection by any one among the first and the second detecting units alone. In the embodiment, a moving mechanism includes the switching lever 410 and the slit 511.

The box-shaped member 302 has a first retracting rib 705. The first retracting rib 705 is provided at a position such that the first retracting rib 705 interferes with the first protrusion 703 that is moved by the operation of the switching lever 410 such that the first retracting rib 705 protrudes toward the first detecting lever 503. The first retracting rib 705 includes a first slope portion 705a that protrudes more as the first retracting rib 705 becomes farther from the first window 406.

Thus, in a case where the first protrusion 703 protrudes from the first window 406, when the switching lever 410 is operated such that the first protrusion 703 is moved to a position at which the first protrusion 703 is retracted from the first window 406, the first detecting lever 503 is pushed by the first slope portion 705a and swings in the direction that the first protrusion 703 moves to approach the unit covering member 501. The first detecting lever 503 swings such that the first protrusion 703 approaches the unit covering member 501 and thereby, the end opposite to the first protrusion 703 of the first detecting lever 503 is moved in the direction that the end moves to move away from the end 505a of the interlocked detecting lever 505.

The box-shaped member 302 has a second retracting rib 706. The second retracting rib 706 is provided at a position such that the second retracting rib 706 interferes with the second protrusion 704 that is moved by the operation of the switching lever 410, such that the second retracting rib 706 protrudes toward the second detecting lever 504. The second retracting rib 706 includes a second slope portion 706a that protrudes more as the second retracting rib 706 becomes farther from the second window 407.

Thus, in a case where the second protrusion 704 protrudes from the second window 407, when the switching lever 410 is operated such that the second protrusion 704 is moved to a position at which the second protrusion 704 is retracted from the second window 407, the second detecting lever 504 is pushed by the second slope portion 706a and swings in the direction that the second protrusion 704 moves to approach the unit covering member 501. The second detecting lever 504 swings such that the second protrusion 704 approaches the unit covering member 501 and thereby, the end opposite to the second protrusion 704 of the second detecting lever 504 is moved in the direction that the end moves to move away from the end 505a of the interlocked detecting lever 505.

In this manner, the position of the end opposite to the first protrusion 703 of the first detecting lever 503 or the position of the end opposite to the second protrusion 704 of the second detecting lever 504 is moved by the first and the second retracting ribs 705 and 706 in the direction that the ends move to move away from the end 505a of the interlocked detecting lever 505 according to the position of the unit frame member 502 and thereby, the interlocked detecting lever 505 is prevented from mistakenly swinging with the intended swinging of the first or the second detecting lever 503 or 504 in the detecting unit that is not activated.

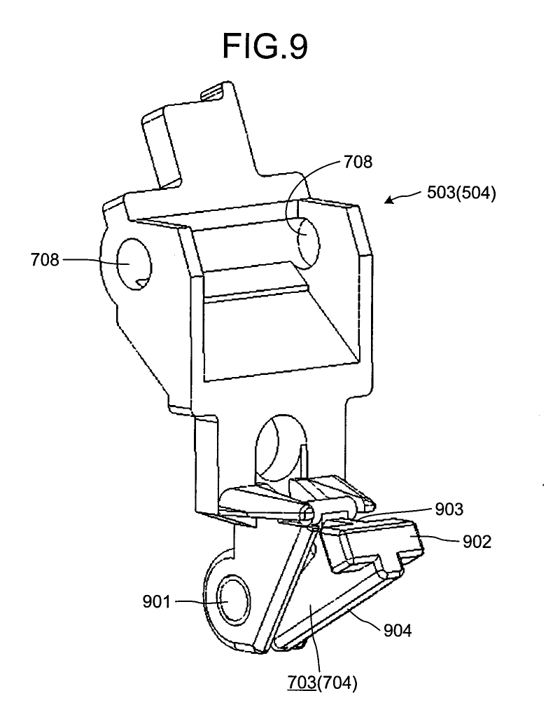

The configuration of the first and the second protrusions 703 and 704 will be described. The first and the second protrusions 703 and 704 have an identical configuration and therefore, the configuration of the protrusion 703 will be herein described. FIGS. 9 to 12 are diagrams for explaining the configuration of the first protrusion 703.

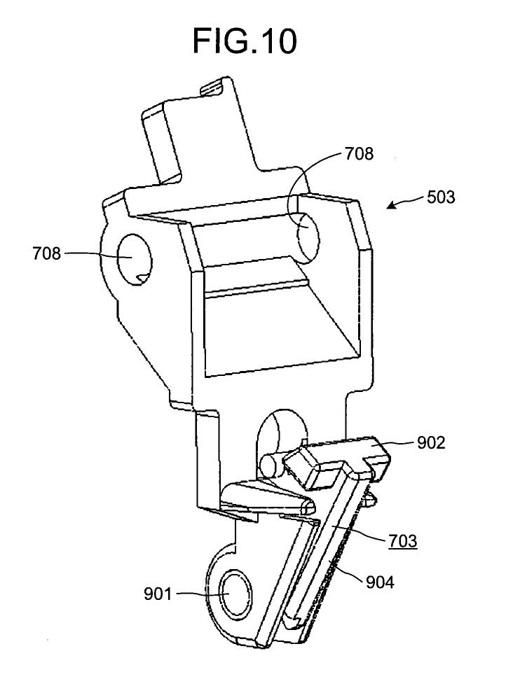

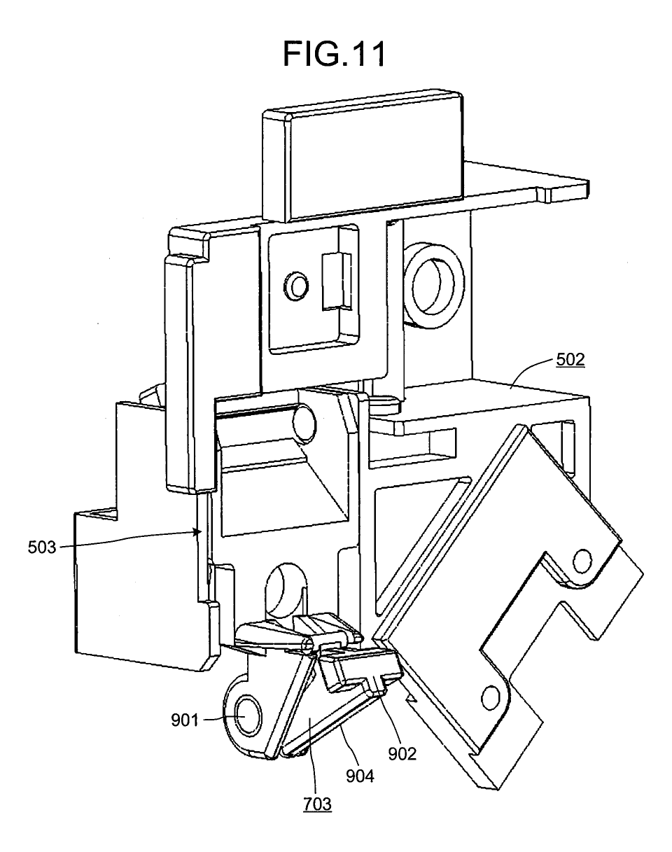

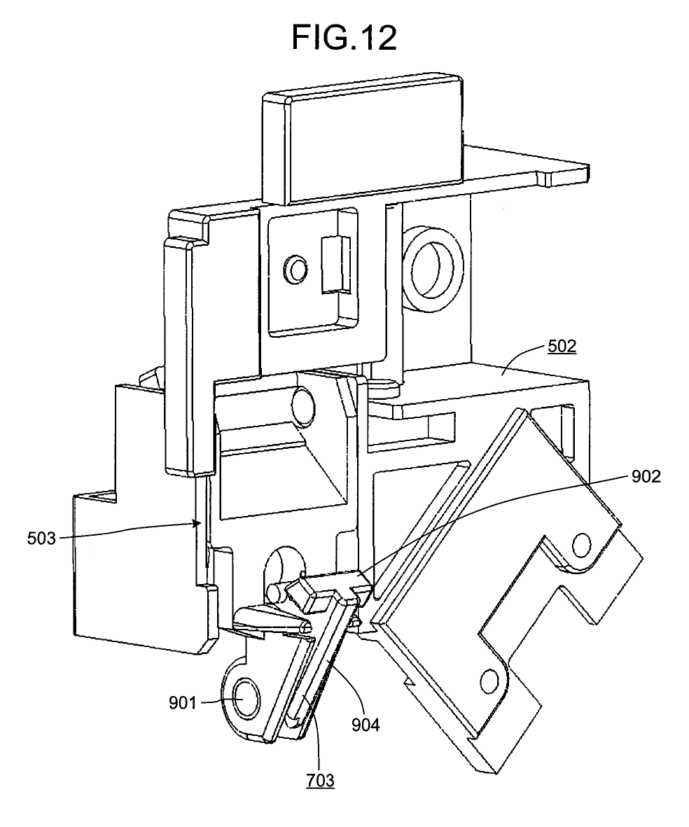

In FIGS. 9 to 12, the first protrusion 703 is coupled to an end of the first detecting lever 503 through a shaft 901 integrated with the first protrusion 703. The first protrusion 703 is provided enabling rotation about the shaft 901. In the embodiment, the first protrusion 703 is configured to be rotatable between a position at which a tip 902 of the first detecting lever 503 depicted in FIG. 9 (or FIG. 11) is away from a hole 708 of the first detecting lever 503 and a position at which a tip 902 depicted in FIG. 10 (or FIG. 12) approaches the hole 708 of the first detecting lever 503. The first protrusion 703 is configured to be rotatable such that the tip 902 approaches the hole 708 of the first detecting lever 503 along the longitudinal direction of the first detecting lever 503.

The first protrusion 703 is biased by a non-depicted biasing member from the position at which the tip 902 depicted in FIG. 10 (or FIG. 12) approaches the hole 708 of the first detecting lever 503 toward the position at which the tip 902 depicted in FIG. 9 (or FIG. 11) is away from the hole 708 of the first detecting lever 503. Thus, when no external force is applied to the first protrusion 703, the first protrusion 703 is positioned at a position at which the tip 902 depicted in FIG. 9 (or FIG. 11) is away from the hole 708 of the first detecting lever 503.

More specifically, the biasing member biasing the first protrusion 703 may be implemented by, for example, a helical torsion coil spring wound around the shaft 901. The biasing member biasing the first protrusion 703 may be implemented by a compression coil spring provided between a face (hereinafter, “inner face”) 903 that is close to the first detecting lever 503 of the first protrusion 703 rotated about the shaft 901, and the first detecting lever 503.

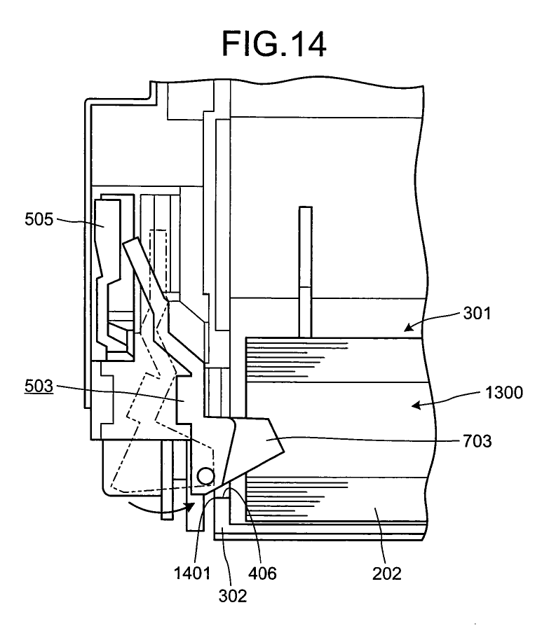

When viewed from a direction parallel to the shaft center of the shaft 901, the first protrusion 703 has a substantially triangular shape having a portion on the side of the tip 902 being thinner than a portion on the side of the shaft 901. The inner face 903 of the first protrusion 703 is adapted to be parallel to the direction of the shaft center of the recording medium 202 wound in a roll. A face (hereinafter, “outer face”) 904 that is far from the first detecting lever 503 when the first protrusion 703 rotates about the shaft 901 of the first protrusion 703, is tilted with respect to the direction of the shaft center of the recording medium 202 wound in a roll. Preferably, the outer face 904 is provided in a plane that substantially coincides with an arc having a radius that is a line connecting a position (see a reference numeral 1401 in FIG. 14) that is most distant from the hole 708 on a distal aspect of the roll-core of the recording medium 202 that has reached the detecting position, to the center of the hole 708.

In the embodiment, the near-end of roll detecting apparatus may be implemented by the recording medium accommodating unit 301, the first and the second detecting levers 503 and 504 respectively including the first and the second protrusions 703 and 704, the detecting sensor 506, and the interlocked detecting lever 505.

### (Detection of Remaining Amount)

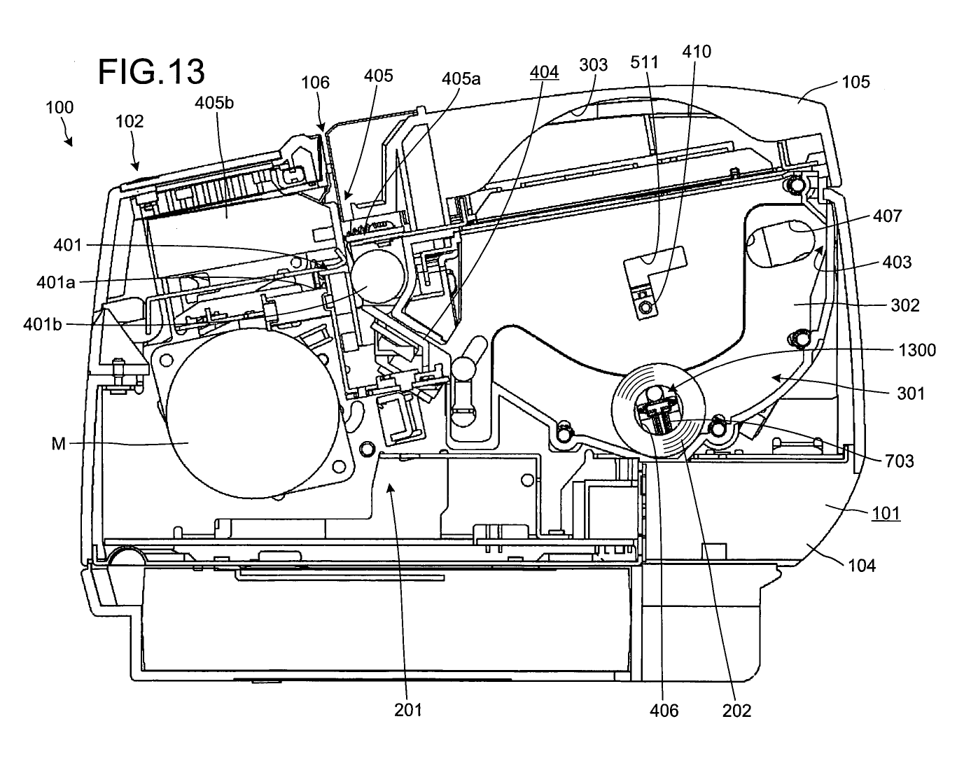

A detection method used by the remaining amount detecting mechanism 500 will be described. FIGS. 13 and 14 are diagrams for explaining the detection method used by the remaining amount detecting mechanism 500. FIG. 13 depicts a cross section (along the A-A line in FIG. 1) of the printer apparatus 100 when the remaining amount of the recording medium 202 wound in a roll and accommodated in the recording medium accommodating unit 301 is the predetermined amount or less. FIG. 14 depicts a cross section of the printer apparatus 100 along a plane that intersects the axial center of the recording medium 202 wound in a roll and accommodated in the recording medium accommodating unit 301, that is parallel to the axial center, and that is parallel to the swinging direction of the first detecting lever 503.

In FIGS. 13 and 14, a space 1300 formed by the core part in the center of the recording medium 202 wound in a roll moves with the consumption of the recording medium 202 held by the first recording medium holding unit 402 such that the space 1300 is received by the lower end of the curved aspect formed by the first recording medium holding unit 402, by the weight of the recording medium 202. When the remaining amount of the recording medium 202 accommodated in the recording medium accommodating unit 301 is of a sufficient amount, the first protrusion 703 abuts the side surface of the recording medium 202 wound in a roll.

When the remaining amount of the recording medium 202 accommodated in the recording medium accommodating unit 301 becomes the predetermined amount or less, the first protrusion 703 faces the space 1300 formed by the core part in the center of the recording medium 202. The first detecting lever 503 is biased by the first compression coil spring in the direction that the first protrusion 703 moves to protrude toward the recording medium accommodating unit 301 and therefore, at the time when the first protrusion 703 faces the space 1300 formed by the core part, the first detecting lever 503 swings such that the first protrusion 703 enters the space 1300 (see FIG. 14).

When the first detecting lever 503 swings such that the first protrusion 703 enters the space 1300 formed by the core part, the end opposite to the first protrusion 703 of the first detecting lever 503 causes the end 505a of the interlocked detecting lever 505 that the end abuts to move toward the unit cover resisting the biasing force of the helical torsion coil spring. Thereby, the interlocked detecting lever 505 swings such that the other end 505b approaches the detection sensor 506.

The other end 505b of the interlocked detecting lever 505 approaches the detection sensor 506 and thereby, the output of the detection sensor 506 varies. More specifically, the other end 505b of the interlocked detecting lever 505 approaches the detection sensor 506 and thereby, the output of the detection sensor 506 varies, for example, from low to high. Based on the output value from the detection sensor 506 or variation in the output of the detection sensor 506, the remaining amount detecting mechanism 500 detects that the remaining amount of the recording medium 202 accommodated in the recording medium accommodating unit 301 is the predetermined amount or less.

In this manner, the remaining amount detecting mechanism 500 of the embodiment detects that the remaining amount of the recording medium 202 is the predetermined amount or less by detecting the position of the core part based on an assumption that the number of turns of the recording medium 202 wound in a roll decreases as the recording medium 202 is consumed and concurrently, the diameter of the recording medium 202 becomes smaller; whereby, the core part moves.

As described above, in the embodiment, the angle of the tilt of the outer face 904 of the first protrusion 703 substantially coincides with the arc having the radius that is the line connecting the position 1401 to the center of the hole 708. Thereby, the remaining amount of the recording medium 202 wound in a roll may be detected accurately to be the predetermined amount or less.

By providing the outer face 904 at the position that substantially coincides with the arc having the radius that is the line connecting the position 1401 and the center of the hole 708, the entire first protrusion 703 quickly enters the space 1300 formed by the roll-core of the recording medium 202 of which the amount remaining is the predetermined amount or less to reach the detecting position. Thereby, the remaining amount of the recording medium 202 wound in a roll is detected assuredly and accurately to be the predetermined amount or less at the time when the remaining amount of the recording medium 202 becomes the predetermined amount or less.

In the above description, the detection method used in the remaining amount detecting mechanism 500 has been described taking an example of a case where the remaining amount of the recording medium 202 held by the first recording medium holding unit 402 is detected using the first detecting unit. However, the detection method used by the remaining amount detecting mechanism 500 may also be described for a case where the remaining amount of the recording medium 202 held by the second recording medium holding unit 403 is detected using the second detecting unit.

The method of detecting the remaining amount of the recording medium 202 held by the second recording medium holding unit 403 using the second detecting unit is same as that for the above detection of the remaining amount by the first detecting unit and therefore, will not be described. When the remaining amount of the recording medium 202 held by the second recording medium holding unit 403 is detected using the second detecting unit, the second detecting lever 504 protrudes from the second window 407.

The printer 201 in the printer apparatus 100 of the embodiment includes a non-depicted control unit that drives and controls the components included in the printer 201. The control unit is provided in the casing 101 of the printer apparatus 100 and may be implemented by, for example, a micro computer that includes memories such as a ROM and a RAM, and a CPU.

The control unit controls the liquid crystal displaying unit 110, the LED lamp 109, and the sound output apparatus based on the result of the detection by the remaining amount detecting mechanism 500. More specifically, when the remaining amount of the recording medium 202 wound in a roll is detected to be the predetermined amount or less based on the output from the detection sensor 506, the control unit drives and controls the liquid crystal displaying unit 110 to display the warning and also drives and controls the LED lamp 109 to blink in red. The control unit further controls the sound output apparatus to output spoken directions or a warning sound.

### (Replacement of Recording Medium)

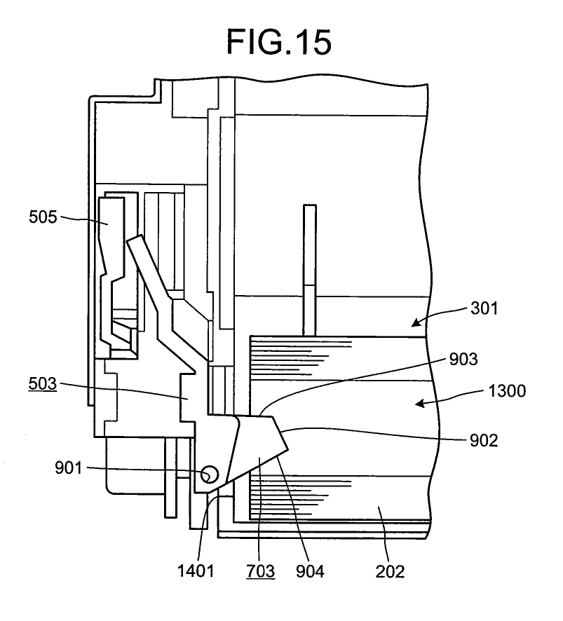

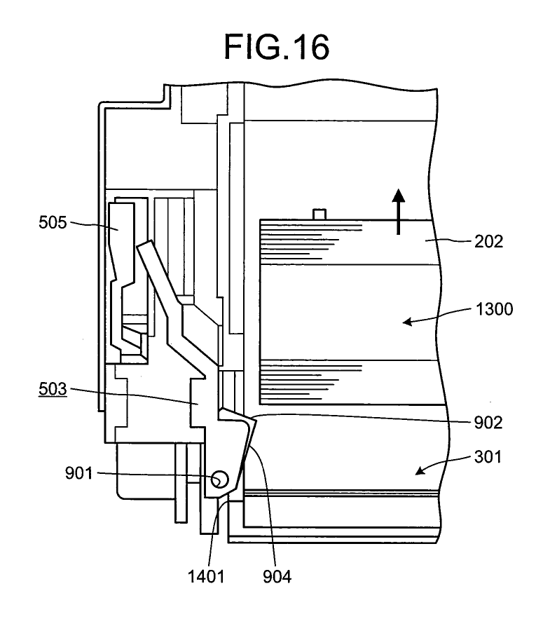

An operation of the remaining amount detecting mechanism 500 for replacement of the recording medium 202 wound in a roll will be described. FIGS. 15 and 16 are diagrams for explaining the operation of the remaining amount detecting mechanism 500 during the replacement of the recording medium 202 wound in a roll. In FIGS. 15 and 16, in a state where the printer 201 is used in the first installation state, the first protrusion 703 enters the space 1300 formed by the roll-core of the recording medium 202 when the remaining amount detecting mechanism 500 detects the near end.

A operator (such as the user of the printer apparatus 100) who executes replacement operation of the recording medium 202 grabs the recording medium 202 of which the amount remaining is the predetermined amount or less, and pulls the recording medium 202 out of the recording medium accommodating unit 301. Thus, the recording medium 202 wound in a roll is pulled out of the recording medium accommodating unit 301; whereby, the first protrusion 703 is pushed by the roll-core of the recording medium 202 wound in a roll and the inner face 903 is rotated in a direction causing the inner face 903 to approach the first detecting lever 503.

As described above, the first protrusion 703 is provided being rotatable in the direction that the roll-core part moves to be detached from the recording medium accommodating unit 301, rotating about an axis that is perpendicular to the direction that the roll-core part moves to be detached from the recording medium accommodating unit 301 and that is parallel to the side face of the recording medium 202. Thereby, the engagement between the first protrusion 703 and the roll-core is disengaged and the recording medium 202 wound in a roll of which the amount remaining is the predetermined amount or less may be removed from the recording medium accommodating unit 301 (see FIG. 16).

The first protrusion 703 is biased by the biasing member and therefore, the first protrusion 703 is rotated in the direction that the inner face 903 moves to move away from the first detecting lever 503 when the recording medium 202 wound in a roll is removed from the recording medium accommodating unit 301. In this state, the operator sets a new recording medium 202 wound in a roll in the recording medium accommodating unit 301. When the new recording medium 202 is set, the new recording medium 202 is put in the recording medium accommodating unit 301 such that the outer circumferential surface of the new recording medium 202 comes into contact with the bottom face portion of the recording medium accommodating unit 301.

The first protrusion 703 abuts a side face of the new recording medium 202 (an end face in the shaft center direction) set in the recording medium accommodating unit 301, and is biased toward the direction that the first protrusion 703 moves to move away from the side face. Thereby, the first detecting lever 503 swings in the direction that an end of the first detecting lever 503 moves to move away from the side face of the recording medium 202.

The first detecting lever 503 swings in the direction that the end of the first detecting lever 503 moves to move away from the side face of the recording medium 202 and thereby, the other end of the interlocked detecting lever 505 moves away from the detecting sensor 506. The other end of the interlocked detecting lever 505 moves away from the detecting sensor 506 and thereby, the remaining amount detecting mechanism 500 is enabled to again detect the remaining amount of the recording medium 202.

Although not depicted, in a case where the printer 201 is used in the second installation state, the second protrusion 704 enters the space 1300 formed by the roll-core of the recording medium 202 when the remaining amount detecting mechanism 500 detects the near end, similarly to the case where the printer 201 is used in the first installation state as above.

The operator (such as the user of the printer apparatus 100) who executes replacement operation of the recording medium 202 grabs the recording medium 202 of which the amount remaining is the predetermined amount or less and pulls the recording medium 202 out of the recording medium accommodating unit 301. In this case, preferably, the recording medium 202 is not directly pulled toward the opening of the box-shaped member 302 and the recording medium 202 is moved toward the central portion of the recording medium accommodating unit 301, matching the movement of the recording medium 202 with the rotation direction of the second protrusion 704 and along the bottom face portion of the recording medium accommodating unit 301.

Thereby, the second protrusion 704 is pushed by the roll-core of the recording medium 202 wound in a roll and the inner face 903 is rotated in a direction causing the inner face 903 to approach the second detecting lever 504. As described, the second protrusion 704 is provided being rotatable in the direction that the roll-core part moves to be detached from the recording medium accommodating unit 301, rotating about an axis that is perpendicular to the direction that the roll-core part moves to be detached from the recording medium accommodating unit 301 and that is parallel to the side face of the recording medium 202. Thereby, the engagement between the second protrusion 704 and the roll-core is disengaged and the recording medium 202 wound in a roll of which the amount remaining is the predetermined amount or less may be removed from the recording medium accommodating unit 301.

The second protrusion 704 is biased by the biasing member and therefore, the second protrusion 703 is rotated in the direction that the inner face 903 moves to move away from the second detecting lever 504 when the recording medium 202 wound in a roll is removed from the recording medium accommodating unit 301. In this state, the operator sets the new recording medium 202 wound in a roll in the recording medium accommodating unit 301. Similarly to the case where the recording medium 202 is pulled out, when the new recording medium 202 is set, preferably, the recording medium 202 is moved toward the second recording medium holding unit 403 matching the movement of the recording medium 202 with the rotation direction of the second protrusion 704 and along the bottom face portion of the recording medium accommodating unit 301.

Thereby, the second protrusion 704 abuts a side face (an end face in the shaft center direction) of the new recording medium 202 set in the recording medium accommodating unit 301, and is biased in the direction that the second protrusion 704 moves to move away from the side face. Thereby, the second detecting lever 504 swings in the direction that an end of the second detecting lever 504 moves to move away from the side face of the recording medium 202.

The second detecting lever 504 swings in the direction that the end of the second detecting lever 504 moves to move away from the side face of the recording medium 202 and thereby, the other end of the interlocked detecting lever 505 becomes distant from the detecting sensor 506. Thus, by other end of the interlocked detecting lever 505 becoming distant from the detecting sensor 506, the remaining amount detecting mechanism 500 is enabled to again detect the remaining amount of the recording medium 202.

A case where the detection sensor 506 is implemented by the transmission photoelectric sensor has been described in the embodiment above. However, the detection sensor 506 is not limited to the transmission photoelectric sensor. More specifically, the detection sensor 506 may also be implemented by, for example, a micro-switch whose output varies corresponding to the presence or absence of contact by the interlocked detecting lever 505.

As described above, the near-end of roll detecting apparatus included in the printer 201 of the embodiment is characterized in that, in the printer 201 including the recording medium accommodating unit 301 that holds the outer circumference portion of the recording medium 202 wound in a roll, the first and the second detecting levers 503 and 504 that are biased to abut the side face of the recording medium 202 and that respectively include at the tips, the first and the second protrusions 703 and 704 that enter the space of the roll-core part when the roll-core part in the center of the recording medium 202 moves to the predetermined position due to the weight of the recording medium 202 as the recording medium 202 is consumed, and a detecting switch that converts the actions of the first and the second detecting levers 503 and 504 into an electric signal; the first and the second protrusions 703 and 704 are provided on the first and the second detecting levers 503 and 504 being rotatable in the direction that the roll-core part moves to be detached from the recording medium accommodating unit 301.

According to the near-end of roll detecting apparatus included in the printer 201 of the embodiment, accompanying the movement of the roll-core part when detached from the recording medium accommodating unit 301, the first and the second protrusions 703 and 704 rotate in the direction that the roll-core part moves to be detached from the recording medium accommodating unit 301 and therefore, the roll-core may be detached easily. Thereby, simplification of the detaching operation of the recording medium 202 may be facilitated without changing, at the first and the second protrusions 703 and 704, the shape necessary for detecting the near end.

According to the near-end of roll detecting apparatus included by the printer 201 of the embodiment, the first and the second protrusions 703 and 704 are characteristically biased in the direction opposite to the direction that the roll-core part moves to be detached from the recording medium accommodating unit 301.

According to the near-end of roll detecting apparatus included in the printer 201 of the embodiment, after the roll-core part is detached, the state of the first and the second protrusions 703 and 704 is restored such that the first and the second protrusions 703 and 704 abut the side face of the recording medium 202 and therefore, preparation for detecting the remaining amount of the new recording medium 202 may be completed by merely accommodating the new recording medium 202 in the recording medium accommodating unit 301. Thereby, simplification of the attaching operation of the recording medium 202 may be facilitated without changing, at the first and the second protrusions 703 and 704, the shape necessary for detecting the near end.

As described above, according to the near-end of roll detecting apparatus included by the printer 201 of the embodiment, simplification of the detaching operation and the attaching operation of the recording medium 202 is facilitated without changing, at the first and the second protrusions 703 and 704, the shape necessary for detecting the near end and therefore, simplification of the replacement operation of the recording medium 202 wound in a roll is facilitated ensuring accuracy in detecting the near end by the remaining amount detecting mechanism 500.

The near-end of roll detecting apparatus included in the printer 201 of the embodiment is characterized in that the first and the second protrusions 703 and 704 are provided being rotatable about the shaft 901 that is perpendicular to the direction that the roll-core part provided in the first and the second detecting levers 503 and 504 moves to be detached from the recording medium accommodating unit 301 and that is parallel to the side face of the recording medium 202.

According to the near-end of roll detecting apparatus included by the printer 201 of the embodiment, with the simple configuration, the first and the second protrusions 703 and 704 may be securely rotated in a direction causing the first and the second protrusions 703 and 704 to become detached from the recording medium accommodating unit 301. Thereby, an increase in the size of the near-end of roll detecting apparatus and the printer 201 including the near-end of roll detecting apparatus due to sophistication of a configuration concerning the detecting of the near end may be suppressed and contribution may be made to downsizing of the printer 201 and the near-end of roll detecting apparatus.

The printer 201 of the embodiment characteristically includes the printing unit that prints on the recording medium 202 fed from the recording medium accommodating unit 301 and the near-end of roll detecting apparatus above. According to the printer 201 of the embodiment, compared to the conventional apparatuses or configurations that detect the near end for a roll of recording medium, simplification of the detaching operation of the recording medium 202 may be facilitated without changing the shapes of the first and the second protrusions 703 and 704 to detect the near end. Thereby, simplification of detaching operation and attaching operation of the recording medium 202 may be facilitated ensuring accuracy in detecting the near end.

### INDUSTRIAL APPLICATION

As described above, the near-end of roll detecting apparatus and the printer according to the present invention are useful for a near-end of roll detecting apparatus that detects a near-end of roll state of a recording medium wound in a roll, and a printer that includes the near-end of roll detecting apparatus and that prints on the recording medium wound in a roll, and are especially suitable for a near-end of roll detecting apparatus and a printer that hold the outer circumferential surface of the recording medium wound in a roll.

What is claimed is:

1. A near-end of roll detecting apparatus comprising:
a recording medium accommodating unit that holds an outer circumferential portion of a recording medium wound in a roll;
a detecting lever that is biased to abut a side aspect of the recording medium, and has on a tip, a protrusion that enters a space of a roll-core part in a center of the recording medium when the roll-core part is moved to a predetermined position by the weight of the recording medium as the recording medium is consumed; and
a detecting switch that converts an action of the detecting lever into an electric signal, wherein
the protrusion is provided on the detecting lever being rotatable in a direction that the roll-core part moves to be detached from the recording medium accommodating unit.

2. The near-end of roll detecting apparatus according to claim 1, wherein
the protrusion is biased in a direction opposite to the direction that the roll-core part moves to be detached from the recording medium accommodating unit.

3. The near-end of roll detecting apparatus according to claim 1, wherein
the protrusion is provided being rotatable about a shaft that is provided on the detecting lever, is perpendicular to the direction that the roll-core part moves to be detached from the recording medium accommodating unit, and is parallel to the side aspect of the recording medium.

4. The near-end of roll detecting apparatus according to claim 2, wherein
the protrusion is provided being rotatable about a shaft that is provided on the detecting lever, is perpendicular to the direction that the roll-core part moves to be detached from the recording medium accommodating unit, and is parallel to the side aspect of the recording medium.

5. A printer comprising:
a printing unit that prints on the recording medium fed from the recording medium accommodating unit; and
the near-end of roll detecting apparatus according to claim 1.

6. A printer comprising:
a printing unit that prints on the recording medium fed from the recording medium accommodating unit; and
the near-end of roll detecting apparatus according to claim 2.

7. A printer comprising:
a printing unit that prints on the recording medium fed from the recording medium accommodating unit; and
the near-end of roll detecting apparatus according to claim 3.

8. A printer comprising:
a printing unit that prints on the recording medium fed from the recording medium accommodating unit; and
the near-end of roll detecting apparatus according to claim 4.
